(19) United States
(12) Patent Application Publication
(10) Pub. No.: US 2008/0060861 A1
(43) Pub. Date: Mar. 13, 2008

(54) ENTERTAINMENT VEHICLE THAT SIMULATES A VEHICLE WITH AN INTERNAL COMBUSTION ENGINE AND MULTIPLE GEAR RATIOS

(76) Inventors: Andrew Baur, Waterford, MI (US); Tony Koenigsknecht, Benton Harbor, MI (US)

Correspondence Address: SCHOX PLC, 209 N. MAIN STREET #200, ANN ARBOR, MI, 48104, US

(21) Appl. No.: 11/854,228

(22) Filed: Sep. 12, 2007

Related U.S. Application Data
(60) Provisional application No. 60/843,918, filed on Sep. 12, 2006.

(51) Int. Cl. B60K 1/00; A63H 17/00; B60L 11/00

(52) U.S. Cl. 180/65.6; 446/465; 701/22

(57) ABSTRACT

The entertainment vehicle of the preferred embodiments includes a motor having an output torque, a gear selector that receives a gear selection amongst a number of simulated gear ratios, a sensor that senses the vehicle speed of the vehicle, and a processor that determines a simulated engine speed based on the gear selection and the sensed vehicle speed. The entertainment vehicle is preferably designed to simulate a vehicle with an internal combustion engine and multiple gear ratios. The entertainment vehicle, however, may be alternatively used in any suitable environment and for any suitable reason.

### CROSS-REFERENCE TO RELATED APPLICATIONS

This application claims the benefit of U.S. Provisional Application No. 60/843,918 filed 12 Sep. 2006 and entitled “Simulation of racecar functionality in an electric entertainment vehicle”, which is incorporated in its entirety by this reference.

### TECHNICAL FIELD

This invention relates generally to the entertainment vehicle field, and more specifically to an improved entertainment vehicle that simulates a vehicle with an internal combustion engine and multiple gear ratios.

### BACKGROUND

For more than a century, man has raced cars. Almost all of these cars have included an internal combustion engine. An internal combustion engine typically operates over a range of 600-7000 revolutions per minute (RPM), and typically performs best over a narrow “powerband” within this range. The wheels of a vehicle, however, rotate between 0 rpm and around 1800 rpm, and the vehicle often requires the greatest torque when it is moving from rest or traveling at a slow velocity. To compensate for these characteristics of internal combustion engines, nearly every car includes a transmission with multiple gear ratios. The selection of an appropriate gear (which occurs by user selection in a vehicle with a manual transmission) allows the transmission to deliver torque to the wheels with the engine in its powerband.

Entertainment vehicles, such as so-call “go-carts”, have typically included internal combustion engines. Pushed by the green movement, these vehicles are slowly being replaced by vehicles with electric motors. Electric motors, in contrast to internal combustion engines, typically operate over a range of 0-10,000 revolutions per minute (RPM), and typically perform equally over this entire range (i.e., they have a flat “torque curve”). Thus, vehicles with electric motors often do not include a transmission. The experience and strategy of driving and racing an entertainment vehicle with electric motors is, however, reduced because the need to select a gear ratio to maximize engine torque and vehicle speed and to maximize engine efficiency and minimize fuel consumption is completely eliminated. This reduction in experience and strategy may reduce the overall entertainment value of vehicles with electric engines, which may reduce the adoption of these vehicles that would reduce pollution and would otherwise benefit society.

Thus, there is a need in the entertainment vehicle field to provide an improved entertainment vehicle that simulates a vehicle with an internal combustion engine and multiple gear ratios. This invention provides such improved entertainment vehicle.

### BRIEF DESCRIPTION OF THE FIGURES

FIG. 1 is a side view of the entertainment vehicle of the preferred embodiments of the invention.

FIG. 2 is a schematic diagram of determining simulated engine speed 26.

FIG. 3 is a schematic drawing of the user interface of the preferred embodiments of the invention.

FIG. 4 is a schematic diagram of determining simulated engine torque.

FIG. 5 is a schematic diagram of determining simulated engine load and simulated engine torque.

FIG. 6 is a schematic diagram of determining simulated fuel consumption and simulated fuel consumption rate.

FIGS. 7 and 8 are schematic diagrams of simulating a manual transmission.

FIG. 9 is a schematic diagram of determining simulated engine damage.

### DESCRIPTION OF THE PREFERRED EMBODIMENTS

The following description of preferred embodiments of the invention is not intended to limit the invention to these embodiments, but rather to enable any person skilled in the art to make and use this invention.

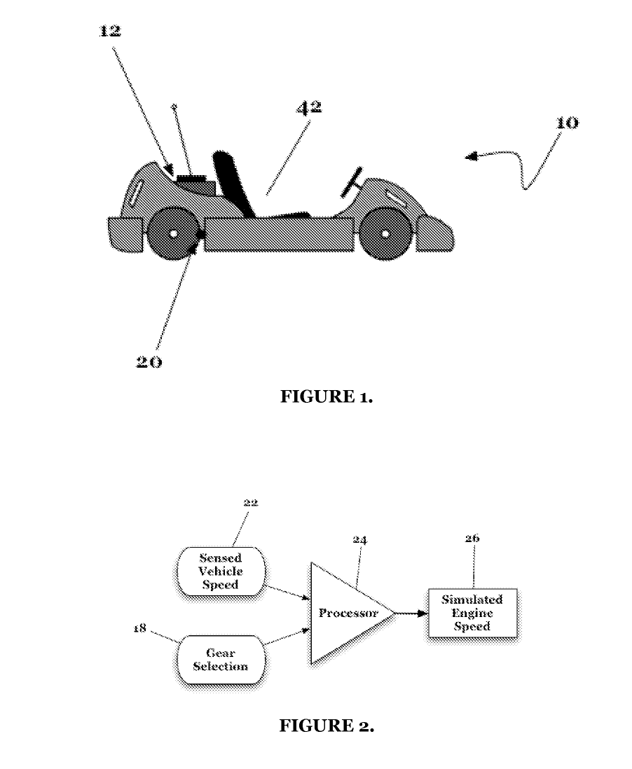

As shown in FIGS. 1 and 2, the entertainment vehicle 10 of the preferred embodiments includes a motor 12 having an output torque, a gear selector that receives a gear selection 18 amongst a number of simulated gear ratios, a sensor 20 that senses the vehicle speed 22 of the vehicle, and a processor 24 that determines a simulated engine speed 26 based on the gear selection 18 and the sensed vehicle speed 22. The entertainment vehicle 10 is preferably designed to simulate a vehicle with an internal combustion engine and multiple gear ratios. The entertainment vehicle 10, however, may be alternatively used in any suitable environment and for any suitable reason.

1. The Entertainment Vehicle

The entertainment vehicle 10 of the preferred embodiments functions to transport a user. Preferably, the entertainment vehicle 10 is a four-wheel cart. Alternatively, the entertainment vehicle 10 may be another wheeled vehicle (such as a motorcycle or a bicycle), a tracked vehicle (such as a snowmobile or a tank), or a railed vehicle (such as a train). The entertainment vehicle 10 may, however, be any suitable vehicle that transports a user.

In the preferred embodiments, the entertainment vehicle 10 includes a motor 12, as shown in FIG. 1, that functions to propel the entertainment vehicle 10. Preferably, the motor 12 is coupled to the wheels 28 of the entertainment vehicle 10 and provides an output torque 14. The motor 12 is preferably an electric motor 12, but may alternatively be any suitable device to propel the entertainment vehicle 10, such as an internal combustion engine, an internal combustion/electric hybrid engine, or even a compressed air engine. The motor 12 may be coupled to at least one of the wheels 28 of the entertainment vehicle 10 directly. Alternatively, the motor 12 may be coupled through a transmission system. The transmission, having a number of actual gear ratios, functions to transmit the output of the motor 12. The number of actual gear ratios is preferably less than the number of simulated gear ratios. The motor 12 may be located in the front of the vehicle, the back of the vehicle, inside a wheel of the vehicle, or in any other suitable location to propel the vehicle. Preferably, the motor 12 is powered by a power source. The power source is preferably a rechargeable electrical battery, but may alternatively be any suitable energy storage system such as a gasoline or diesel fuel source, a fuel cell system, or any other suitable rechargeable or replenishable energy storage system. The power source may alternatively be a hybrid power source including an energy storage system and a fueled propulsion power source such as an internal combustion engine. The power source may additionally or alternatively include a direct connection to a power grid.

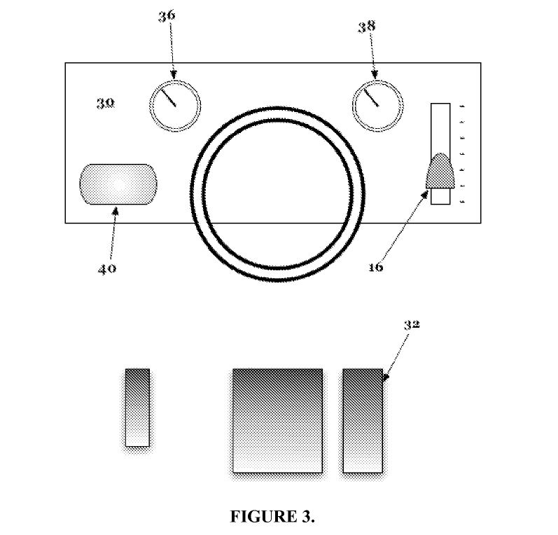

As shown in FIG. 3, the entertainment vehicle 10 of the preferred embodiments preferably includes a user interface 30 that functions to accept the vehicle input from a user and to communicate with the processor 24. The user interface 30 preferably includes one or more of the following subsystems: a steering device to accept steering input (such as a steering wheel, handlebars, or any other suitable steering devices), acceleration and deceleration devices to accept acceleration (or velocity) input 34 and deceleration input (such as throttles, accelerator pedals 32, or brakes adapted for hand or foot activation, or any other suitable acceleration and deceleration devices), and an activation device to accept other inputs (such as a touch screen, voice recognition, or any other suitable means of accepting input from the user). The user interface 30 may include any suitable combination and permutation of these various devices and those described below.

The user interface 30 of the preferred embodiment additionally includes a gear selector 16 that functions to receive a gear selection 18 amongst a number of simulated gear ratios. The gear selector 16 is preferably one of several variations. In a first variation, the gear selector 16 is a lever. The gear selector 16 in this variation is preferably an electric gear shifter or a standard gear shifter similar to those used in manual transmission vehicles. In a second variation, the gear selector 16 is a dial. In a third variation, the gear selector 16 is a push/pull paddle located near the steering wheel. Although the gear selector 16 is preferably one of these three variations, the gear selector 16 may be any suitable means of accepting a gear selection 18 from the user, such as voice recognition.

The user interface 30 may also further include feedback devices to communicate information from the entertainment vehicle 10 to the user. The feedback devices preferable include a simulated tachometer 36 that displays the simulated engine speed 26. The tachometer 36 is preferably a dial. The dial may be an actual mechanical dial or may be an image on a screen. Alternatively, the tachometer 36 may be any suitable device to display the simulated engine speed 26. The feedback devices also preferable include a simulated fuel gauge 38 that displays the simulated fuel level. The fuel gauge 38 is preferably a dial. The dial may be an actual mechanical dial or may be an image on a screen. Alternatively, the fuel gauge 38 may be any suitable device to display the simulated fuel level.

The feedback devices preferable include at least one speaker 40 that creates simulated engine sounds based on the simulated engine speed 26. The simulated engine sounds preferably include an engine sound that simulates the engine sound of an internal combustion engine. The simulated engine sounds preferably further include a knock sound that simulates the engine sound of an internal combustion engine during knocking. The speaker 40 preferably creates the knock sound based on the simulated engine speed (and, in some variations, the simulated engine load). The speaker 40 is preferably a standard speaker 40, but may alternatively be any suitable system that creates simulated engine sounds based on the simulated engine speed 26. There may be multiple speakers 40 to create a surround sound system. The speaker 40 is preferably located near the head of the user, in the headrest, or in a suitable location in the vehicle. The speaker 40 may alternatively be in a headset worn by the user. The speaker 40 is preferably in the vehicle, but may alternatively be located at a remote location.

As shown in FIG. 1, the feedback devices may also include tactile devices to provide other feedback to the user (such as a rumble seat, a vibrating steering device, or any other suitable means of providing tactile feedback) based, at least in part, on the simulated engine speed 26. The entertainment vehicle 10 preferably includes a seat 42 coupled to the vehicle and a tactile transducer coupled to the seat 42 that creates simulated engine vibrations based on the simulated engine speed 26.

The sensor 20 of the preferred embodiments functions to sense the vehicle speed 22 of the vehicle. The sensor 20 is preferably located on or near the wheels 28 of the vehicle but may be located in any suitable location to sense the vehicle speed 22 of the vehicle. The sensor 20 may sense the rotational velocity or number of rotations per unit of time of the wheels 28 or any suitable rotating component on the vehicle. Alternatively, the sensor 20 may sense the distance traveled, the speed at which the driving surface moves below the car, or the time it takes to travel a distance. The sensor 20 may be any suitable device in any suitable location to sense the vehicle speed 22 of the vehicle.

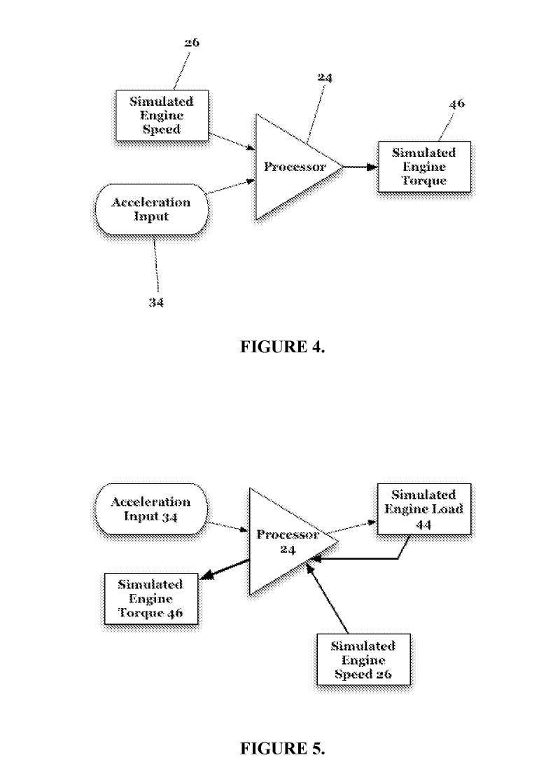

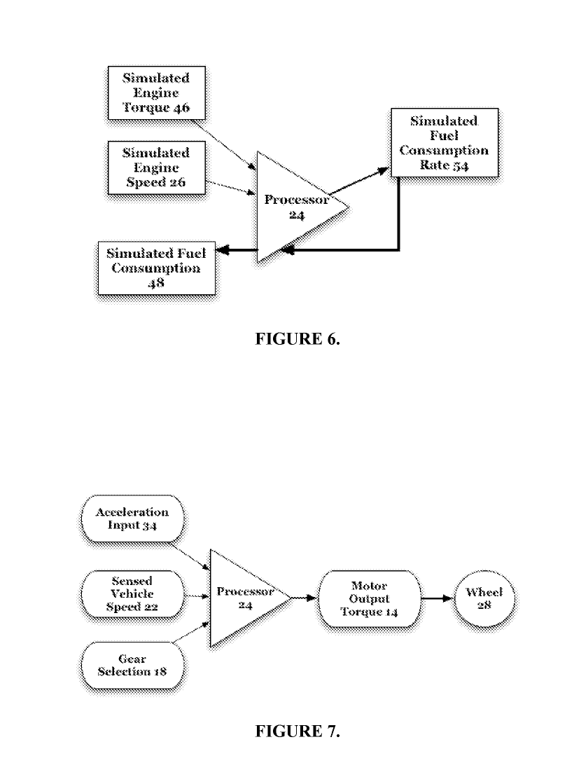

The processor 24 of the preferred embodiments functions to determine simulated properties of the vehicle based on sensed properties, inputs, and/or other simulated properties. More specifically, as shown in FIG. 2, the processor 24 functions to determine a simulated engine speed 26 based on the gear selection 18 and the sensed vehicle speed 22. The processor 24 is coupled to the user interface 30, including the gear selector 16, and to the sensor 20. The processor 24 is preferably a digital controller, but may alternatively be an analog controller, a mechanical controller, a microcontroller, or any other suitable controller. The processor 24 is preferably located in the vehicle, but may alternatively be located in a remote area. Further, if located in a remote area, the processor 24 may be a central processor 24, separate from the vehicle, and adapted to function as the processor 24 for at least one vehicle and preferably multiple vehicles. In addition to determining a simulated engine speed 26, the processor 24 is further adapted to determine a simulated engine load 44 (FIG. 5), to determine a simulated engine torque 46 (FIGS. 4 and 5), to determine a simulated fuel consumption 48 (FIG. 6), to determine any other suitable property, and to use the simulated properties to adjust the entertainment vehicle 10 and enrich the user experience (FIGS. 7-9) as described below. Although the processor 24 is preferably one of these several variations and combinations, the processor 24 may be any suitable device to perform the desired functions and determine the desired properties.

In the preferred embodiments, the entertainment vehicle 10 further includes a memory that stores relationships between sensed properties, inputs, and/or simulated properties. The memory is preferably located in the vehicle, but may alternatively be separate from the vehicle and/or located at a remote location. The memory is preferably a conventional memory chip, such as RAM, but may alternatively be any suitable device able to store information. The relationships stored by the memory preferably include at least one of the relationships discussed in the following section, and are used to determine at least one of the properties discussed in the following section.

2. Determining Simulated Properties

A shown in FIG. 2, the processor preferably determines a simulated engine speed 26 using a first relationship of the preferred embodiments. The first relationship is a relationship between the simulated engine speed 26 and the sensed vehicle speed 22 for each of the simulated gear ratios. The processor 24, using this first relationship, determines the simulated engine speed 26 based on the gear selection 18, the sensed vehicle speed 22, and the relationship between the simulated engine speed 26 and the sensed vehicle speed 22 for the given gear selection 18. This relationship is preferably a set of simulated engine speed over sensed vehicle speed ratios, each specific to a gear selection 18. The simulated gear ratios preferably mimic those of an internal combustion engine, and more preferably those of a high performance vehicle, but may alternatively be any suitable relationship between the simulated engine speed 26 and the sensed vehicle speed 22 for the given gear selection 18. The simulated gear ratios may be modified to adjust the challenge of the entertainment vehicle posed to the user.

As shown in FIG. 4, the processor preferably determines a simulated engine torque using a second relationship of the preferred embodiments. The second relationship is a relationship between simulated engine torque 46, simulated engine speed 26, and the acceleration input 34. The processor 24, using this relationship, determines a simulated engine torque 46 based on the relationship between the simulated engine torque 46, the simulated engine speed 26, and the acceleration input 34. This relationship is preferably a torque curve representing engine speed versus engine torque 46. The torque curve is preferably that of an internal combustion engine, and more preferably that of a high performance vehicle, but may alternatively be any suitable relationship between simulated engine torque 46, simulated engine speed 26, and acceleration input 34. The torque curve may be modified to adjust the challenge of the entertainment vehicle posed to the user.

As shown in FIG. 5, the second relationship may additionally be scaled by the simulated engine load 44. The engine load 44 is determined by the processor 24 based on the acceleration input 34. In general, the further the acceleration pedal is pressed or the higher the acceleration input, the higher the simulated engine load 44. The processor 24 using this relationship scaled by simulated engine load 44, determines a simulated engine torque 46 based on the relationship between simulated engine torque 46 and simulated engine speed 26.

As shown in FIG. 6, the processor preferably determines a simulated fuel consumption 48 using a third relationship of the preferred embodiments. In a first variation, the third relationship is a relationship between a simulated fuel consumption rate 54, the simulated engine speed 26, and the simulated engine torque 46. The processor 24 using this relationship, determines a simulated fuel consumption rate 54 based on the simulated engine speed 26 and the simulated engine torque 46. The processor then determines a simulated fuel consumption 48 based on an integration of the simulated fuel consumption rate 54.

In a second variation, the third relationship of the preferred embodiments is a relationship between the simulated engine torque 46, a simulated a cylinder air mass, the simulated engine speed 26, a simulated engine air flow rate, a simulated stoichiometric air-fuel ratio, a simulated fuel consumption rate, and a simulated fuel consumption. The processor 24 using this relationship, determines a simulated cylinder air mass based on the simulated engine torque 46, determines a simulated engine air flow rate based on the simulated cylinder air mass and the simulated engine speed 26, determines a simulated fuel consumption rate based on the simulated engine air flow rate and a simulated stoichiometric air-fuel ratio (preferably by dividing the simulated engine air flow rate by the simulated stoichiometric air-fuel ratio), and determines a simulated fuel consumption based on the simulated fuel consumption rate (preferably by integrating the simulated fuel consumption rate). In either variation, the fuel consumption may be modified to adjust the challenge of the entertainment vehicle posed to the user.

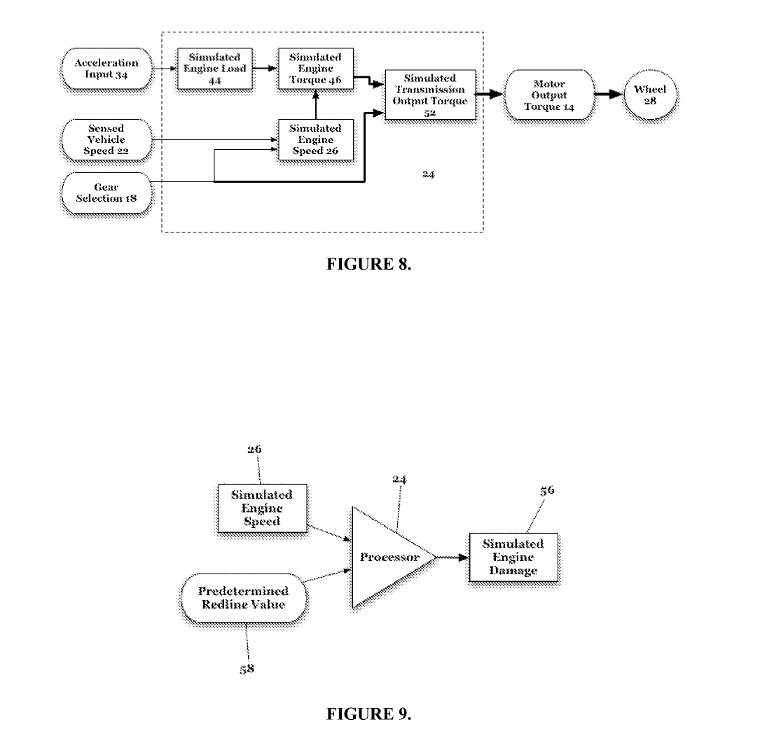

As shown in FIG. 8, the processor preferably determines a simulated transmission output torque 52 using a fourth relationship of the preferred embodiments. The fourth relationship is a relationship between a simulated transmission output torque 52, the simulated engine torque 46, and the gear selection 18. The processor 24 using this relationship, determines a simulated transmission output torque 52 based on the simulated engine torque 46 and the gear selection 18. This relationship is preferably the simulated engine torque 46 divided by the ratio of simulated engine speed 26 over sensed vehicle speed 22, specific to the specific gear selection 18, but may alternatively be any suitable relationship between a simulated transmission output torque 52, the simulated engine torque 46, and the gear selection 18.

3. Using Simulated Properties

Using the simulated properties and/or sensed properties of the vehicle, the processor preferably controls the vehicle, adjusts the motor, controls the feedback devices, and/or performs any other suitable function or any other suitable combination to allow the user of the entertainment vehicle 10 to experience the sensation and strategy of driving a vehicle with an internal combustion engine and multiple gear ratios.

As shown in FIGS. 7 and 8, the processor preferably simulates a manual transmission. The processor, through controlling the vehicle and/or adjusting the motor 12, allows the user of the entertainment vehicle 10 to experience the sensation and strategy of driving a vehicle with an internal combustion engine and multiple gear ratios and to experience the strategy of shifting gears to appropriately to maximize vehicle speed 22. The processor 24 preferably adjusts the motor 12 based on the simulated engine torque 46 and/or the simulated transmission output torque 52, as shown in FIGS. 7 and 8 respectively. More specifically, the processor 24 adjusts the motor 12 such that the output torque 14 of the motor 12 is approximately equal to the simulated transmission output torque 52. In most situations, the simulated engine torque or simulated transmission torque will be less than the engine torque demanded by the user, which will disadvantage the user for selecting the less-than-ideal gear ratio for that particular moment. Thus, with the creation of these disadvantages, the focus of the users will return to the selection of the ideal gear ratio, which will simulate the experience of a race in a vehicle with an internal combustion engine and multiple gear ratios.

The processor 24 may also simulate the temporary pause in the transmission of engine torque to the wheels that occurs when shifting or changing gears of a manual transmission. The processor 24 preferably adjusts the motor 12 such that the output torque 14 of the motor 12 is about zero upon the change of the gear selection 18 amongst the simulated gear ratios. This might simulate the “jerk” the user would feel when shifting an actual manual transmission. The adjustment may last a predetermined time period, may last until the user selects another gear, may be dependant on the use of a simulated clutch pedal, or may be dependent on any other suitable device or action.

As shown in FIG. 9, the processor may also simulate engine damage 56. The processor preferably allows the user of the entertainment vehicle 10 to experience the sensation and strategy of driving a vehicle with an internal combustion engine and multiple gear ratios and to experience the necessity to keep the simulated engine speed 26 below a predetermined redline value 58 to avoid simulated engine damage 56. This effectively limits the vehicle speed a user can safely achieve for a particular gear selection. The processor 24 determines a simulated engine damage 56 based on the simulated engine speed 26 and a predetermined redline value 58. A redline value is the maximum engine speed at which an engine can run without causing damage to the engine. The processor 24 then adjusts the motor 12 based on the simulated engine damage 56. The processor 24 adjusts the motor 12 such that the output torque 14 of the motor 12 is significantly lower than the simulated transmission output torque 52. Once simulated engine damage 56 has occurred, the entertainment vehicle 10 will preferably slow or stop until action is taken. While the simulated engine damage 56 preferably occurs based upon the comparison of the simulated engine speed 26 and the predetermined redline value 58, the simulated engine damage may also occur based on simulated engine temperature, simulated engine knock, or any other suitable source of engine damage.

The processor may also simulate engine noise and/or vibration. The processor, through controlling the feedback devices (specifically the speakers 40), allows the user of the entertainment vehicle 10 to experience the aural sensation of driving a vehicle with an internal combustion engine internal combustion engine and multiple gear ratios. The processor controls the speaker 40 to create simulated engine sounds based on the simulated engine speed 26, simulated engine load 44, or any other suitable property. The simulated engine sounds preferably include an engine sound that simulates the engine sound of an internal combustion engine. The simulated engine sounds preferably further include a knock sound that simulates the engine sound of an internal combustion engine during knocking. The processor controls the speaker 40 to create the knock sound based on the simulated engine speed (and, in some variations, the simulated engine load). The simulated engine sounds are preferably prerecorded engine sounds from an actual vehicle with an internal combustion engine, but may alternatively be any other suitable simulated engine sounds. The user may utilize the engine noise to determine simulated engine speed, simulated engine damage, to prevent engine damage, or for any other suitable function. If the user damages the engine, they may be forced to pit, or perform another suitable action, to recover from this condition. The processor may also control the speaker 40 to create any other suitable sounds such as weather, traffic signals, crowds, or other vehicles.

The processor, through controlling the feedback devices (specifically the tactile devices), allows the user of the entertainment vehicle 10 to experience the tactile sensation of driving a vehicle with an internal combustion engine and multiple gear ratios. The processor controls the tactile devices to create simulated engine vibrations based on the simulated engine speed 26 or any other suitable property. The entertainment vehicle 10 preferably includes a seat 42 coupled to the vehicle, as shown in FIG. 1, and a tactile transducer coupled to the seat 42 that creates simulated engine vibrations based on the simulated engine speed 26.

The processor may also simulate fuel level. The processor, through controlling the vehicle and/or adjusting the motor, allows the user of the entertainment vehicle 10 to experience the sensation and strategy of driving a vehicle with an internal combustion engine and multiple gear ratios and to experience the strategy of the strategy of driving and shifting to conserve fuel. The processor 24 adjusts the motor 12 based on the simulated fuel consumption 48. More specifically, the processor 24 determines a fuel level by subtracting the simulated fuel consumption from a predetermined amount and whereupon the simulated fuel consumption 48 is greater than a predetermined amount, the processor 24 adjusts the motor 12 such that the output torque 14 of the motor 12 is significantly lower than the simulated transmission output torque 52. This preferably causes the entertainment vehicle 10 to stop or slow as the simulated fuel level decreases. If the user runs out of fuel, they may be forced to pit, or perform another suitable action, to recover from this condition. Additionally, the vehicle may handle differently or accelerate differently based upon different fuel levels and due to more or less mass.

Although omitted for conciseness, the preferred embodiments include every combination and permutation of the various entertainment vehicles 10, the various motors 12, the various gear selectors 16, the various sensors 20, the various processors 24, the various simulated properties, and the various uses of the simulated properties.

As a person skilled in the art will recognize from the previous detailed description and from the figures and claims, modifications and changes can be made to the preferred embodiments of the invention without departing from the scope of this invention defined in the following claims.

I claim:

1. An entertainment vehicle that simulates a vehicle with an internal combustion engine and multiple gear ratios, comprising:
a motor having an output torque;
a gear selector that receives a gear selection amongst a number of simulated gear ratios;
a sensor that senses the vehicle speed of the vehicle; and
a processor that determines a simulated engine speed based on the gear selection and the sensed vehicle speed.

2. The entertainment vehicle of claim 1 further comprising a memory that stores a relationship between simulated engine speed and sensed vehicle speed for the gear selection, wherein the processor determines the simulated engine speed based on the gear selection, the sensed vehicle speed, and the stored relationship between simulated engine speed and sensed vehicle speed for the gear selection.

3. The entertainment vehicle of claim 1 whereupon the change of the gear selection amongst the simulated gear ratios, the processor adjusts the motor such that the output torque of the motor is about zero.

4. The entertainment vehicle of claim 1 further comprising an accelerator pedal that receives an acceleration input, and wherein the processor determines a simulated engine torque based on the simulated engine speed and the acceleration input, and wherein the processor adjusts the motor based on the simulated engine torque.

5. The entertainment vehicle of claim 4 further comprising a memory that stores a relationship between simulated engine torque, simulated engine speed, and acceleration input, wherein the processor determines a simulated engine torque based on the stored relationship between simulated engine torque, simulated engine speed, and acceleration input.

6. The entertainment vehicle of claim 5 wherein the processor determines a simulated engine load based on the acceleration input, and wherein the processor scales the stored relationship between simulated engine torque and simulated engine speed by simulated engine load, and wherein the processor determines a simulated engine torque based on the stored relationship between simulated engine torque and simulated engine speed, scaled by simulated engine load.

7. The entertainment vehicle of claim 4 wherein the processor determines a simulated transmission output torque based on the simulated engine torque and the gear selection, and wherein the processor adjusts the motor based on the simulated transmission output torque.

8. The entertainment vehicle of claim 7 wherein the processor adjusts the motor such that the output torque of the motor is approximately equal to the simulated transmission output torque.

9. The entertainment vehicle of claim 7 wherein the processor determines a simulated engine damage based on the simulated engine speed and a predetermined redline value, and wherein the processor adjusts the motor based on the simulated engine damage.

10. The entertainment vehicle of claim 9 wherein the processor adjusts the motor such that the output torque of the motor is significantly lower than the simulated transmission output torque.

11. The entertainment vehicle of claim 7 wherein the processor determines a simulated fuel consumption rate based on the simulated engine speed and the simulated engine torque, wherein the processor determines a simulated fuel consumption based on an integration of the simulated fuel consumption rate, and wherein the processor adjusts the motor based on the simulated fuel consumption.

12. The entertainment vehicle of claim 11 whereupon the simulated fuel consumption is greater than a predetermined amount, the processor adjusts the motor such that the output torque of the motor is significantly lower than the simulated transmission output torque.

13. The entertainment vehicle of claim 12 further comprising a simulated fuel gauge that displays a simulated fuel level, wherein the processor determines the simulated fuel level based on the simulated fuel consumption and the predetermined amount.

14. The entertainment vehicle of claim 1 further comprising a simulated tachometer that displays the simulated engine speed.

15. The entertainment vehicle of claim 1 further comprising a speaker that creates simulated engine sounds based on the simulated engine speed.

16. The entertainment vehicle of claim 15 wherein the simulated engine sounds include an engine sound that simulates the engine sound of an internal combustion engine.

17. The entertainment vehicle of claim 15 wherein the simulated engine sounds further include a knock sound that simulates the engine sound of an internal combustion engine during knocking.

18. The entertainment vehicle of claim 1 further comprising a seat coupled to the vehicle, and a tactile transducer coupled to the seat that creates simulated engine vibrations based on the simulated engine speed.

19. The entertainment vehicle of claim 1 further comprising a transmission that transmits the output of the motor, the transmission having a number of actual gear ratios, the number of actual gear ratios being less than the number of simulated gear ratios.

20. A method of simulating, with an entertainment vehicle having a motor, a vehicle having an internal combustion engine and multiple gear ratios, the method comprising the steps of:
receiving a gear selection amongst a number of simulated gear ratios;
sensing the vehicle speed of the vehicle;
determining a simulated engine speed based on the gear selection and the sensed vehicle speed; and
adjusting an aspect of the entertainment vehicle based on the simulated engine speed.
